(19) United States
(12) Patent Application Publication
(10) Pub. No.: US 2026/0012048 A1
(43) Pub. Date: Jan. 8, 2026

(54) STEPPING MOTOR

(71) Applicant: AAC Microtech (Changzhou) Co., Ltd., Changzhou City (CN)

(72) Inventor: Lubin Mao, Changzhou (CN)

(21) Appl. No.: 19/012,775

(22) Filed: Jan. 7, 2025

Related U.S. Application Data
(63) Continuation of application No. PCT/CN2024/103157, filed on Jul. 2, 2024.

(51) Int. Cl. H02K 1/14; H02K 1/18; H02K 5/16; H02K 37/00

(52) U.S. Cl. CPC H02K 1/145; H02K 1/18; H02K 5/161; H02K 37/00

(57) ABSTRACT

The present invention relates to a stepping motor. The stepping motor of the present invention is characterized in that the stator assembly is arranged to surround the rotor assembly and is spaced from the rotor assembly. The rotor assembly includes a shaft and magnetic steels which are sleeved and fixed on the shaft. The claw-pole assembly is accommodated and fixed inside the outer shell. The stepping motor also includes a mounting bracket which extends along the axial direction of the shaft and is fixed to the housing. The space outside the stepping motor body is fully utilized, so that the improvement of the structural strength can be achieved without increasing the placement space of the components. The bending-resistance strength of the stepping motor body is enhanced by the mounting bracket, thereby ensuring that the stepping motor has sufficient height to improve the torque performance.

### CROSS-REFERENCE TO RELATED APPLICATIONS

This application is a continuation of International Application No. PCT/CN2024/103157, filed on Jul. 2, 2024, the entire content of which is incorporated herein by reference.

### TECHNICAL FIELD

The present invention relates to the technical field of electric motors, in particular to a stepping motor.

### BACKGROUND

Stepping motors have been widely applied in fields such as electric motors and generators due to their compact structure, high power density, high working efficiency, and remarkable energy-saving and consumption-reducing benefits. In recent years, the industrial field has an increasingly urgent demand for equipment that directly drives loads using stepping motors. The extensive application of these stepping motor direct-drive devices will generate inestimable energy-saving benefits.

In the application of electronic devices, existing stepping motors are increasingly required to have a minimized diameter. While reducing the diameter, in order to ensure sufficient output torque, it is necessary to further increase the height of the motor, thus resulting in a slender structure of the motor. And this design inevitably leads to a serious decline in the structural strength of the motor and insufficient bending resistance strength.

Therefore, it is necessary to provide a new type of stepping motor to solve the above-mentioned technical problems.

### SUMMARY

The present invention is aimed at enhancing the bending resistance strength of the stepping motor body on the premise of not additionally increasing the placement space of the motor, thereby ensuring that the stepping motor has sufficient height to improve its torque performance.

In order to solve the above technical problem, the present invention provides a stepping motor. The stepping motor includes a housing, a stator assembly fixed to the housing and a rotor assembly supported on the housing and forming a rotational connection with the housing. The stator assembly is arranged to surround the rotor assembly and is spaced from the rotor assembly. The rotor assembly includes a shaft and a magnetic steel sleeved and fixed on the shaft, and each of two ends of the shaft respectively forms a rotational connection with the housing. The stator assembly is provided in plurality and fixed to the housing, the plurality of stator assemblies are respectively sleeved on the rotor assembly and arranged along an axial direction of the shaft; each of the stator assemblies includes an outer shell coaxially arranged with the housing and fixed to the housing, a claw-pole assembly arranged to surround an outer periphery of the rotor assembly and a coil sleeved on the claw-pole assembly, with the claw-pole assembly being accommodated and fixed inside the outer shell. The housing includes an enclosure wall formed by all the outer shells abutting against each other, a first cover plate and a second cover plate oppositely arranged along the axial direction of the shaft, the enclosure wall is sandwiched between the first cover plate and the second cover plate, and each of two ends of the shaft respectively forms a rotational connection with the first cover plate and the second cover plate. The stepping motor further includes a mounting bracket, the mounting bracket extends along the axial direction of the shaft and is fixed to the housing.

Preferably, the mounting bracket includes two sidewalls spaced oppositely to each other and extending along the axial direction of the shaft, a connecting wall connecting the same side of the two sidewalls, and a through hole penetrating through the connecting wall; each of two ends of the sidewall is fixed on the first cover plate and the second cover plate respectively, the connecting wall extends along the axial direction of the shaft and abuts against the enclosure wall, the through hole is arranged on the connecting wall and abuts against the enclosure wall, and extends along the axial direction of the shaft.

Preferably, the first cover plate, the second cover plate and an outer periphery of the enclosure wall are in a circular shape, the sidewall is arranged tangentially to the first cover plate and the second cover plate respectively, and the two sidewalls are positioned at two opposite sides of the housing respectively; the connecting wall is tangent to the enclosure wall and makes the through hole exactly opposite to a tangency position of the connecting wall with the enclosure wall.

Preferably, a distance from the connecting wall to a center of the shaft is equal to a radius of the first cover plate.

Preferably, the stepping motor further includes a first bearing and a second bearing, the first bearing is sleeved on one end of the shaft adjacent to the first cover plate and is embedded and fixed to the first cover plate, and the second bearing is sleeved on one end of the shaft adjacent to the second cover plate and is embedded and fixed to the second cover plate.

Preferably, the stepping motor further includes two spacers spaced oppositely to each other, the two spacers are sleeved on the shaft, and each of the two spacers is fixed to each of two ends of the magnetic steel respectively.

Preferably, the claw-pole assembly includes a claw-pole skeleton fixed to the outer shell, a first claw-pole and a second claw-pole relatively accommodated and fixed within the claw-pole skeleton and cooperate with each other, the claw-pole skeleton at least partially penetrates through one side of the outer shell along a radial direction of the shaft, and the coil is sleeved and fixed to the claw-pole skeleton.

Preferably, the claw-pole skeleton includes a skeleton body accommodated and fixed to the outer shell and an extending arm extending from the skeleton body and penetrating through the outer shell along the radial direction of the shaft, the first claw-pole and the second claw-pole are accommodated and fixed within the skeleton body, and the coil is sleeved on the skeleton body.

Preferably, the magnetic steel is provided in plurality, and the magnetic steels are fixedly arranged at intervals on an outer peripheral side of the shaft.

Compared with the prior art, the stepping motor of the present invention is characterized in that the stator assembly is arranged to surround the rotor assembly and is spaced from the rotor assembly. The rotor assembly includes a shaft and magnetic steels which are sleeved and fixed on the shaft, and the end of the shaft forms the rotational connection with the housing. The stator assembly is provided in plurality and fixed to the housing. The plurality stator assemblies are respectively sleeved on the rotor assembly and arranged along the axial direction of the shaft. Each stator assembly includes an outer shell which is coaxially arranged with and fixed to the housing, a claw-pole assembly which is arranged to surround the outer periphery of the rotor assembly, and a coil which is sleeved on the claw-pole assembly. The claw-pole assembly is accommodated and fixed inside the outer shell. The stepping motor also includes a mounting bracket which extends along the axial direction of the shaft and is fixed to the housing. The space outside the stepping motor body is fully utilized, so that the improvement of the structural strength can be achieved without increasing the placement space of the components. The bending-resistance strength of the stepping motor body is enhanced by the mounting bracket, thereby ensuring that the stepping motor has sufficient height to improve the torque performance.

### BRIEF DESCRIPTION OF THE DRAWINGS

In order to explain the technical solutions of the embodiments of the present invention more clearly, the following will briefly introduce the accompanying drawings used in the embodiments. Apparently, the drawings in the following description are only some embodiments of the present invention. Those of ordinary skill in the art can obtain other drawings based on these drawings without creative work.

FIG. 1 is a schematic diagram of a 3D structure of a stepping motor according to an embodiment of the present invention;

FIG. 2 is a schematic exploded view of the 3D structure of the stepping motor according to the embodiment of the present invention;

FIG. 3 is a top view of the stepping motor according to the embodiment of the present invention;

FIG. 4 is a cross-sectional view cut along A-A line of FIG. 3; and

FIG. 5 is a schematic exploded view of a mounting bracket structure of the stepping motor according to the embodiment of the present invention.

In the drawing, 100 is a stepping motor, 1 is a housing, 11 is a first cover plate, 12 is a second cover plate, 13 is an enclosure wall, 2 is a rotor assembly, 21 is a shaft, 22 is a magnetic steel, 3 is a stator assembly, 31 is an outer shell, 32 is a claw-pole assembly, 321 is a claw-pole skeleton, 3211 is a skeleton body, 3212 is an extending arm, 322 is a first claw-pole, 323 is a second claw-pole, 33 is a coil, 4 is a mounting bracket, 41 is a sidewall, 42 is a connecting wall, 43 is a through hole, 51 is a first bearing, 52 is a second bearing, and 6 is a spacer.

### DETAILED DESCRIPTION OF THE EMBODIMENTS

The technical solutions in the embodiments of the present invention will be clearly and completely described below in conjunction with the accompanying drawings in the embodiments of the present invention. Apparently, the described embodiments are only a part of the embodiments of the present invention, rather than all the embodiments. Based on the embodiments in the present invention, all other embodiments obtained by those ordinarily skilled in the art without doing creative work shall fall within the protection scope of the present invention.

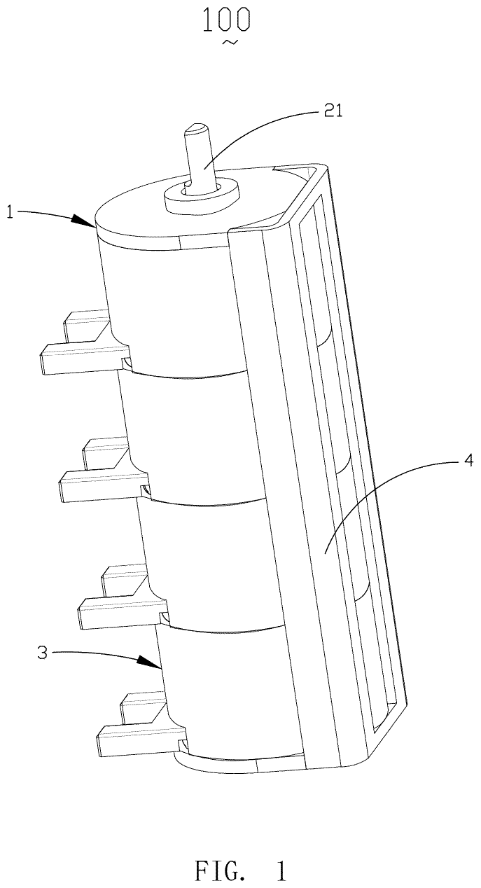

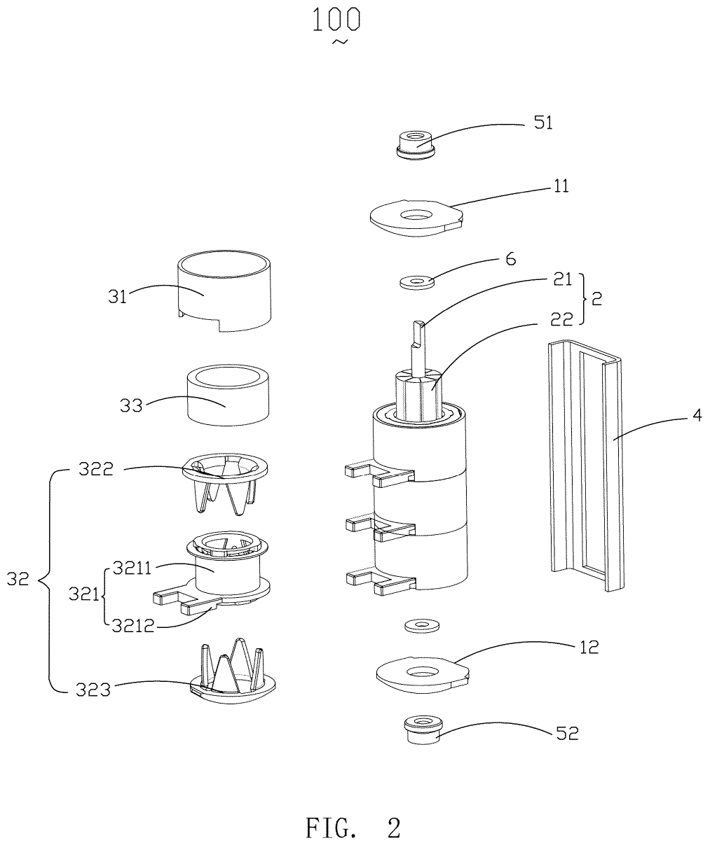

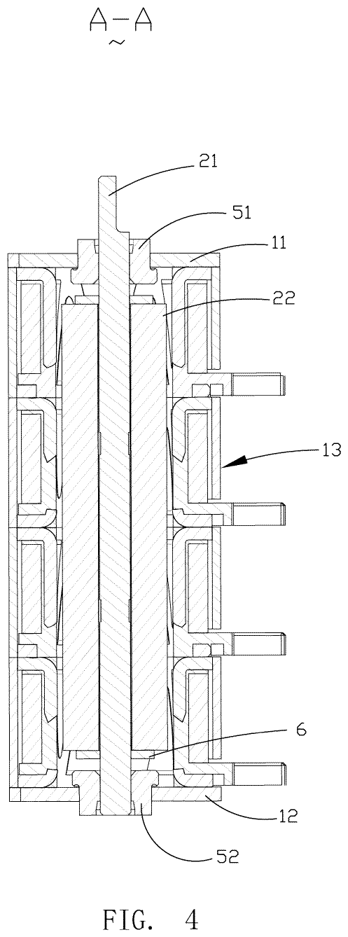

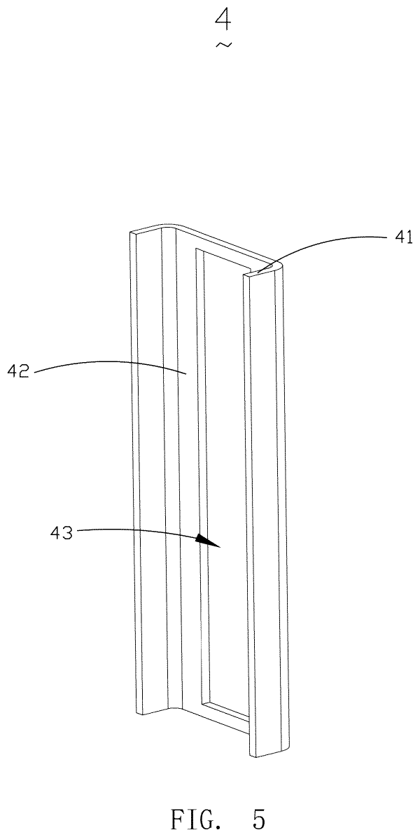

Referring to FIG. 1 to FIG. 5, an embodiment of the present invention provides a stepping motor 100. The stepping motor 100 includes a housing 1, a stator assembly 3 fixed to the housing 1 and a rotor assembly 2 supported on the housing 1 and forming a rotational connection with the housing 1, and the stator assembly 3 is arranged to surround the rotor assembly 2 and is spaced from the rotor assembly.

The rotor assembly 2 includes a shaft 21 and a magnetic steel 22 sleeved and fixed on the shaft 21, and each of two ends of the shaft 21 respectively forms a rotational connection with the housing 1.

The stator assembly 3 is provided in plurality and fixed to the housing 1, the plurality of stator assemblies 3 are respectively sleeved on the rotor assembly 2 and arranged along an axial direction of the shaft 21; each of the stator assemblies 3 includes an outer shell 31 coaxially arranged with the housing 1 and fixed to the housing 1, a claw-pole assembly 32 arranged to surround an outer periphery of the rotor assembly 2 and a coil 33 sleeved on the claw-pole assembly 32, with the claw-pole assembly 32 being accommodated and fixed inside the outer shell 31.

The housing 1 includes an enclosure wall 13 formed by all the outer shells 31 abutting against each other, a first cover plate 11 and a second cover plate 12 oppositely arranged along the axial direction of the shaft 21, the enclosure wall 13 is sandwiched between the first cover plate 11 and the second cover plate 12, and each of two ends of the shaft 21 respectively forms a rotational connection with the first cover plate 11 and the second cover plate 12.

The stepping motor 100 further includes a mounting bracket 4, the mounting bracket 4 extends along the axial direction of the shaft 21 and is fixed to the housing 1.

In this embodiment, the mounting bracket 4 includes two sidewalls 41 spaced oppositely to each other and extending along the axial direction of the shaft 21, a connecting wall 42 connecting the same side of the two sidewalls 41, and a through hole 43 penetrating through the connecting wall 42; each of two ends of the sidewall 41 is fixed on the first cover plate 11 and the second cover plate 12 respectively, the connecting wall 42 extends along the axial direction of the shaft 21 and abuts against the enclosure wall 13, the through hole 43 is arranged on the connecting wall 42 and abuts against the enclosure wall 13, and extends along the axial direction of the shaft 21.

In this embodiment, the first cover plate 11, the second cover plate 12 and an outer periphery of the enclosure wall 13 are in a circular shape, the sidewall 41 is arranged tangentially to the first cover plate 11 and the second cover plate 12 respectively, and the two sidewalls 41 are positioned at two opposite sides of the housing 1 respectively; the connecting wall 42 is tangent to the enclosure wall 13 and makes the through hole 43 exactly opposite to a tangency position of the connecting wall 42 with the enclosure wall 13.

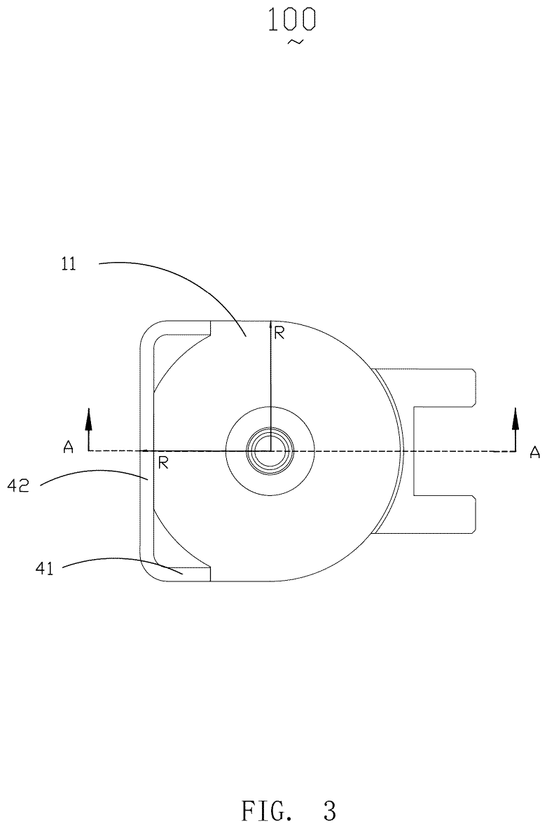

In this embodiment, a distance from the connecting wall 42 to a center of the shaft 21 is equal to a radius of the first cover plate 11. Referring to FIG. 3 which is a top view of the stepping motor 100 according to the embodiment of the present invention, the stepping motor 100, the stepping motor 100 is in a cylindrical shape, structures of the first cover plate 11 and the second cover plate 12 are the same. In the figure, R is the radius of the first cover plate 11 (a radius of the stepping motor 100 is equal to the radius of the first cover plate 11). When the stepping motor 100 is installed in other devices such as mobile phones, the occupied space takes the form of a rectangle with a side length of 2R. Since the mounting bracket 4 is still arranged within the range of this rectangle, no additional space will be occupied. The space outside the stepping motor 100 is fully utilized, thereby enhancing the structural strength of the stepping motor 100 without increasing the placement space.

In this embodiment, the stepping motor 100 further includes a first bearing 51 and a second bearing 52, the first bearing 51 is sleeved on one end of the shaft 21 adjacent to the first cover plate 11 and is embedded and fixed to the first cover plate 11, and the second bearing 52 is sleeved on one end of the shaft 21 adjacent to the second cover plate 12 and is embedded and fixed to the second cover plate 12.

In this embodiment, the stepping motor 100 further includes two spacers 6 spaced oppositely to each other, the two spacers 6 are sleeved on the shaft 21, and each of the two spacers 6 is fixed to each of two ends of the magnetic steel 22 respectively.

In this embodiment, the claw-pole assembly 32 includes a claw-pole skeleton 321 fixed to the outer shell 31, a first claw-pole 322 and a second claw-pole 323 relatively accommodated and fixed within the claw-pole skeleton 321 and cooperate with each other, the claw-pole skeleton 321 at least partially penetrates through one side of the outer shell 31 along a radial direction of the shaft 21, and the coil 33 is sleeved and fixed to the claw-pole skeleton 321.

In this embodiment, the claw-pole skeleton 321 includes a skeleton body 3211 accommodated and fixed to the outer shell 31 and an extending arm 3212 extending from the skeleton body 3211 and penetrating through the outer shell 31 along the radial direction of the shaft 21, the first claw-pole 322 and the second claw-pole 323 are accommodated and fixed within the skeleton body 3211, and the coil 33 is sleeved on the skeleton body 3211.

In this embodiment, the magnetic steel 22 is provided in plurality, and the magnetic steels 22 are fixedly arranged at intervals on an outer peripheral side of the shaft 21.

Compared with the prior art, the stepping motor of the present invention is characterized in that the stator assembly is arranged to surround the rotor assembly and is spaced from the rotor assembly. The rotor assembly includes a shaft and magnetic steels which are sleeved and fixed on the shaft, and the end of the shaft forms the rotational connection with the housing. The stator assembly is provided in plurality and fixed to the housing. The plurality stator assemblies are respectively sleeved on the rotor assembly and arranged along the axial direction of the shaft. Each stator assembly includes an outer shell which is coaxially arranged with and fixed to the housing, a claw-pole assembly which is arranged to surround the outer periphery of the rotor assembly, and a coil which is sleeved on the claw-pole assembly. The claw-pole assembly is accommodated and fixed inside the outer shell. The stepping motor also includes a mounting bracket which extends along the axial direction of the shaft and is fixed to the housing. The space outside the stepping motor body is fully utilized, so that the improvement of the structural strength can be achieved without increasing the placement space of the components. The bending-resistance strength of the stepping motor body is enhanced by the mounting bracket, thereby ensuring that the stepping motor has sufficient height to improve the torque performance.

The above is only the preferred embodiments of the present invention. It should be noted that those of ordinary skill in the art can further make improvements without departing from the concept of the present invention. These improvements shall all fall within the protection scope of the present invention.

What is claimed is:

1. A stepping motor comprising:
a housing;
a stator assembly fixed to the housing; and
a rotor assembly supported on the housing and forming a rotational connection with the housing,
wherein the stator assembly is arranged to surround the rotor assembly and is spaced from the rotor assembly;
the rotor assembly comprises a shaft and a magnetic steel sleeved and fixed on the shaft, and each of two ends of the shaft respectively forms a rotational connection with the housing;
the stator assembly is provided in plurality and fixed to the housing, the plurality of stator assemblies are respectively sleeved on the rotor assembly and arranged along an axial direction of the shaft; each of the stator assemblies comprises an outer shell coaxially arranged with the housing and fixed to the housing, a claw-pole assembly arranged to surround an outer periphery of the rotor assembly and a coil sleeved on the claw-pole assembly, with the claw-pole assembly being accommodated and fixed inside the outer shell;
the housing comprises an enclosure wall formed by all the outer shells abutting against each other, a first cover plate and a second cover plate oppositely arranged along the axial direction of the shaft, the enclosure wall is sandwiched between the first cover plate and the second cover plate, and each of two ends of the shaft respectively forms a rotational connection with the first cover plate and the second cover plate;
the stepping motor further comprises a mounting bracket, the mounting bracket extends along the axial direction of the shaft and is fixed to the housing.

2. The stepping motor according to claim 1, wherein the mounting bracket comprises two sidewalls spaced oppositely to each other and extending along the axial direction of the shaft, a connecting wall connecting the same side of the two sidewalls, and a through hole penetrating through the connecting wall; each of two ends of the sidewall is fixed on the first cover plate and the second cover plate respectively, the connecting wall extends along the axial direction of the shaft and abuts against the enclosure wall, the through hole is arranged on the connecting wall and abuts against the enclosure wall, and extends along the axial direction of the shaft.

3. The stepping motor according to claim 2, wherein the first cover plate, the second cover plate and an outer periphery of the enclosure wall are in a circular shape, the sidewall is arranged tangentially to the first cover plate and the second cover plate respectively, and the two sidewalls are positioned at two opposite sides of the housing respectively; the connecting wall is tangent to the enclosure wall and makes the through hole exactly opposite to a tangency position of the connecting wall with the enclosure wall.

4. The stepping motor according to claim 3, wherein a distance from the connecting wall to a center of the shaft is equal to a radius of the first cover plate.

5. The stepping motor according to claim 1, wherein the stepping motor further comprises a first bearing and a second bearing, the first bearing is sleeved on one end of the shaft adjacent to the first cover plate and is embedded and fixed to the first cover plate, and the second bearing is sleeved on one end of the shaft adjacent to the second cover plate and is embedded and fixed to the second cover plate.

6. The stepping motor according to claim 1, wherein the stepping motor further comprises two spacers spaced oppositely to each other, the two spacers are sleeved on the shaft, and each of the two spacers is fixed to each of two ends of the magnetic steel respectively.

7. The stepping motor according to claim 1, wherein the claw-pole assembly comprises a claw-pole skeleton fixed to the outer shell, a first claw-pole and a second claw-pole relatively accommodated and fixed within the claw-pole skeleton and cooperate with each other, the claw-pole skeleton at least partially penetrates through one side of the outer shell along a radial direction of the shaft, and the coil is sleeved and fixed to the claw-pole skeleton.

8. The stepping motor according to claim 7, wherein the claw-pole skeleton comprises a skeleton body accommodated and fixed to the outer shell and an extending arm extending from the skeleton body and penetrating through the outer shell along the radial direction of the shaft, the first claw-pole and the second claw-pole are accommodated and fixed within the skeleton body, and the coil is sleeved on the skeleton body.

9. The stepping motor according to claim 1, wherein the magnetic steel is provided in plurality, and the magnetic steels are fixedly arranged at intervals on an outer peripheral side of the shaft.
